(19) United States
(12) Patent Application Publication
(10) Pub. No.: US 2026/0075026 A1
(43) Pub. Date: Mar. 12, 2026

(54) NOTIFICATION CLUSTERING

(71) Applicant: MICRO FOCUS LLC, Wilmington, DE (US)

(72) Inventors: Vamsi Krishna, Bangalore (IN); Harinath Jarugula, Bangalore (IN)

(73) Assignee: MICRO FOCUS LLC, Wilmington, DE (US)

(21) Appl. No.: 18/827,360

(22) Filed: Sep. 6, 2024

(51) Int. Cl. H04L 51/224; H04L 51/222

(52) U.S. Cl. CPC H04L 51/224; H04L 51/222

(57) ABSTRACT

A server device determines a notification for a specific client device. The server device determines a cluster of client devices to which the specific client device has been assigned based on network proximity such that the client devices of the cluster have network proximity to one another. The server device determines a leader client device of the cluster. The server device transmits the notification for the specific client device to the leader client device over a communication session between the server device and the leader client device. The leader client device transmits the notification to the specific client device.

### BACKGROUND

Notification permit users to receive notifications on their client devices, such as computers like notebook, laptop, and other types of computers, as well as smartphones, tablet computing devices, and so on. Notification services can involve server devices sending notifications to client devices in a real-time manner to keep users apprised of information as it is generated. The users may be immediately alerted to notifications on their client devices as the notifications are received. For instance, the notifications may be pushed to the client devices, which means that the client devices do not have to continuously poll the server devices to receive the notifications.

### BRIEF DESCRIPTION OF THE DRAWINGS

FIG. 1A is a diagram of an example system for push notification clustering, which includes a server device and clusters of client devices, and

FIG. 1B is a diagram of an example computing device by which these devices can be implemented.

FIG. 2 is a flowchart of an example method that is performed to push a notification from the server device to a client device via the leader client device of the cluster to which the client device has been assigned.

FIG. 3 is a flowchart of an example method that is performed to add a client device to a cluster to receive push notifications.

FIGS. 4A, 4B, and 4C are flowcharts of example methods that are performed when client devices are reclustered into new clusters.

FIG. 5 is a flowchart of an example method that is performed when the leader client device of a cluster has failed.

FIG. 6 is a flowchart of an example method that is performed when the network connectivity of a client device of a cluster has changed.

FIGS. 7A and 7B are flowcharts of example methods that are performed when a client device of a cluster no longer is to receive push notifications from the server device.

### DETAILED DESCRIPTION

As noted above, notifications can ensure that users are kept apprised of information as the information is generated. Notifications can be sent from server devices to client devices of the users in a push or pull manner. In a pull technique, a client device periodically sends a request to a server device to retrieve any new notifications; that is, the client device “pulls” notifications from the server device. In a push technique, the server device sends notifications to the client device without the client device having to periodically send a request to retrieve them; that is, the server device “pushes” notifications to the client device.

One example type of pull technique is known as short polling, such as hypertext transport protocol (HTTP) short polling, in which a client device frequently checks with a server device to retrieve any new notifications. Specifically, a client device establishes an HTTP connection with a server device to request new notifications. Once the new notifications have been sent to the client device, the connection is closed. The connection is also closed if there are no new notifications to retrieved.

Short polling is inefficient, because in all likelihood there will not be any new notifications the vast majority of times. Resources on both the client and server devices, as well as network bandwidth, are therefore unnecessarily utilized. Moreover, an individual server device may not be able to provide a notification service for a large number of client devices via short polling; the number of requests sent by the client devices can overwhelm the server device.

Another example type of pull technique is known as long polling, such as HTTP long polling, which may also be considered a false push technique in that to some extent it emulates a true push technique. As in short polling, long polling involves a client device establishing a connection (e.g., an HTTP connection) with a server device to request new notifications. However, unlike in short polling in which the connection is immediately closed if there are no new notifications, in long polling the connection is kept open for a specified length of time.

In long polling, once new notifications are generated, they are sent to the client device and the connection is closed. If no new notifications are generated during the specified length of time, the connection is closed at the end of this time period. Long polling is more efficient than short polling, albeit not as efficient as true push techniques insofar as a client device still has to request new notifications. The difference is that in long polling the client device does not immediately close the connection with the server device if there are no new notifications as it does in short polling. An example of long polling is that provided by the bidirectional-streams over synchronous HTTP (BOSH) protocol.

Example types of true push techniques include the WebSocket and protocol server-sent events (SSE). Both the WebSocket protocol and SSE permit a client device to establish a persistent connection with a server device over which the server device can then send notifications without the client device first requesting them. The WebSocket protocol provides for a full-duplex connection in which the client device can also send messages to the server device, whereas SSE provides for just a half-duplex connection, specifically an HTTP connection.

Persistent connections such as those established via the WebSocket protocol, SSE, and other true push techniques permit more efficient notification delivery than both short and long polling and other pull techniques, because the client device does not have to periodically request new notifications from the server device. Long polling, such as that afforded by the BOSH protocol, to some degree emulates true push techniques and thus can be considered a false push technique or a hybrid push-pull technique, insofar as while the connection with the server device is open the client device does not have to request new notifications.

While both true and false push techniques are more efficient than short polling, they do not scale well. A client device establishes a persistent connection (in true push techniques) or a relatively long connection (in false push techniques) with a particular server device—i.e., with a particular instance of a server. Cloud-based technologies can provide for automatic server scaling, where actual server instances are increased and decreased based on loan.

However, maintenance of established connections between client devices and particular server instances can become problematic. New server instances can be instantiated to provide the notification service to new client devices, but already established connections cannot be shifted to them. Once a client device has established a connection with a particular server device, a different server device cannot transparently take over the connection. Rather, the existing connection has to be terminated and a new connection established between the client device and the different server device.

Techniques described herein ameliorate these issues by providing for push notification clustering. Client devices are clustered based on network proximity. A push communication session, which may be a persistent connection for true push techniques like the WebSocket protocol and SSE or a relatively long HTTP or other connection for false push techniques like long polling like that provided by the BOSH protocol, is established between just one client device of a cluster and the server device. This client device is referred to as the leader client device.

When a notification is generated for any client device in the cluster, the server device sends the notification to the leader client device, and not to the client device for which the notification is intended. The leader client device in turn transmits the notification to the intended client device upon receipt (assuming that the leader is itself not the intended recipient). The server device, therefore, just has to maintain one connection per cluster, as opposed to one connection per client device.

For example, if a cluster has 100 client devices, instead of there being 100 push communication sessions between the individual client devices and the server device, there will be just one communication session, between the leader client device and the server device. A given server device can therefore more efficiently provide a notification service to the client devices, and will be able to serve notifications to a greater number of client devices. Scaling is likewise improved, because transferring responsibility for a cluster of client devices to a different server instance involves the termination of only one existing communication session and the creation of only one new communication session.

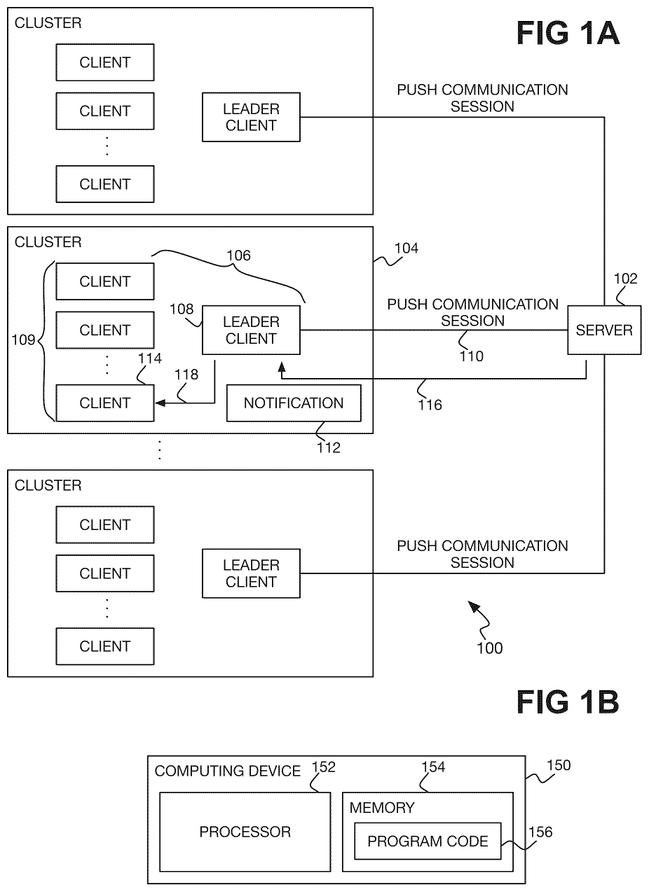

FIG. 1A shows an example system 100 for push notification clustering. The system 100 includes a server device 102 and clusters 104 of client devices 106. The client devices 106 can be those for individual users, and can include smartphones, tablet computing devices, computers such as desktop, laptop, and notebook computers, as well as other types of computing devices. The server device 102 provides a notification service to the client devices 106 by which the client devices 106 receive notifications intended for them individually or in groups.

The client devices 106 of each cluster 104 include a leader client device 108 and one or more other client devices 109. That is, each cluster 104 includes a leader client device 108, which is one of the client devices 106. The client devices 106 of a cluster 104 may in cooperation with each other elect which of them is to serve as the leader client device 108, and then inform the server device 102.

The client devices 106 are clustered over the clusters 104 based on network proximity. That is, the client devices 106 of a given cluster 104 have network proximity to one another. The client devices 106 of one cluster 104 may have more network proximity to each other than to the client devices 106 of another cluster 104.

Network proximity can refer to the physical closeness or logical interconnectedness of the client devices 106, and can be an indication as to how close the client devices 106 are to one another. For example, network proximity can be specified as a logical distance specified by the number of hops or latency between client devices 106 when communicating with one another. As another example, network proximity can instead be specified as an actual or estimated physical distance between client devices 106.

A push communication session 110 is established between the server device 102 and the leader client device 108 of each cluster 104. The push communication session 110 is a push-oriented connection over which the leader client device 108 of a cluster 104 receives notifications from the server device 102 that are intended for any client device 106 of the cluster 104.

Examples of push communication sessions 110 include persistent connections that are established via true push techniques such as the WebSocket protocol, as well as long-term connections that are established via false push techniques (i.e., hybrid push-pull techniques). As an example of the latter, the long-term connection may be a long-term HTTP connection that is established in accordance with long polling.

At any given time, there is no more than one push communication session 110 in existence for each cluster 104, which is between the leader client device 108 thereof and the server device 102. No push communication sessions 110 otherwise currently exist between the server device 102 and any other client device 109 of each cluster 104.

When a notification 112 is generated for transmission to a specific client device 114 of a cluster 104, the server device 102 transmits the notification 112 to the leader client device 108 of the cluster 104 over the push communication session 110 with that leader client device 108, per arrow 116. Upon receipt, the leader client device 108 then transmits the notification 112 to the client device 114 for which it is intended, per arrow 118.

The server device 102, in other words, transmits the notification 112 for the specific client device 114 only to the leader client device 108 of the cluster 104 to which the client device 114 belongs. The server device 102 does not transmit the notification 112 directly to the specific client device 114 that is the intended recipient of the notification 112.

If a notification is intended for more than one client device 106 of the same cluster 104, the server device 102 may transmit just a single instance of the notification to the leader client device 108 of this cluster 104. The leader client device 108 may then broadcast the single notification instance to the intended recipient client devices 106, or may individually transmit a copy of the notification to each such client device 106.

If a notification is intended for client devices 106 in different clusters 104, the server device 102 may broadcast the notification to the leader client devices 108 of these clusters 104, or may transmit a copy of the notification to the leader client device 108 of each such cluster 104. The leader client device 108 of each cluster 104 then transmits the notification to each intended recipient client device 106 in its cluster 104.

FIG. 1B shows an example computing device 150. Each of the client devices 106 can be implemented as the computing device 150, for instance. Similarly, the server device 102 may be implemented as the computing device 150. The server device 102 may also be implemented as more than one computing device 150, in a distributed computing topology.

The computing device 150 includes at least a processor 152 and memory 154, the latter which is an example of a non-transitory computer-readable data storage medium and which stores program code 156. The program code 156 is executable by the processor 152 to perform processing. This processing can include the methods described in the detailed description.

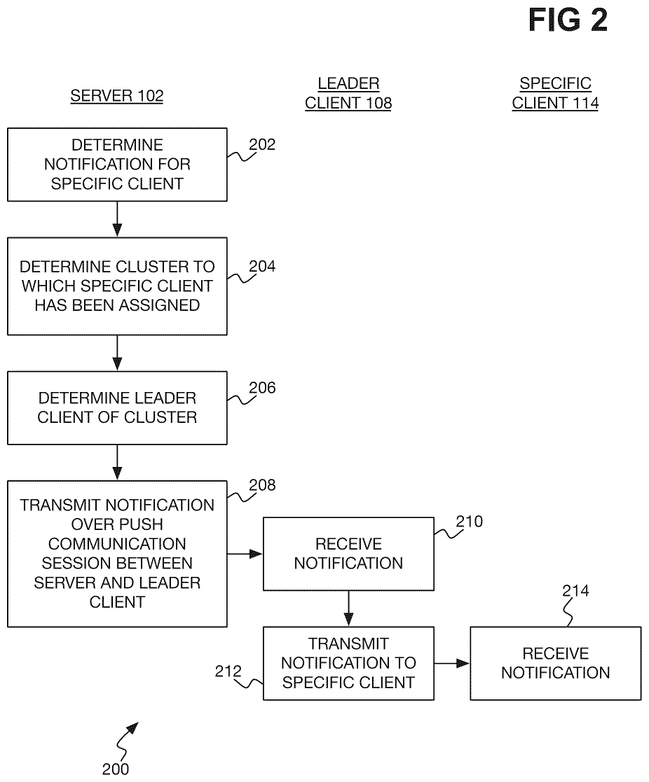

FIG. 2 shows an example method 200 for transmitting a notification 112 for the specific client device 114 of a cluster 104 from the server device 102 via the leader client device 108 of that cluster 104. The method 200 begins with the server device 102 determining the notification 112 (202). The server device 102 may, for example, generate the notification 112 itself.

As another example, the server device 102 may receive the notification 112 from another server device that generated the notification 112. In this case, the server device 102 may provide the notification service by which notifications generated by other server devices are transmitted to their intended recipient client devices 106.

The server device 102 determines the cluster 104 to which the specific client device 114 has been assigned (204) and the leader client device 108 of that cluster 104 (206). For example, the server device 102 may look up the specific client device 114 in a database that stores which client devices 106 are assigned to which clusters 104, and which client device 106 is the leader client device 108 for each cluster 104.

The server device 102 then transmits the notification 112 to the leader client device 108 over a push communication session 110 between the server device 102 and the leader client device 108 (208). The leader client device 108 receives the notification 112 (210), and transmits it to the specific client device 114 (212). The client device 114 thus receives the notification 112 directly from the leader client device 108 (214).

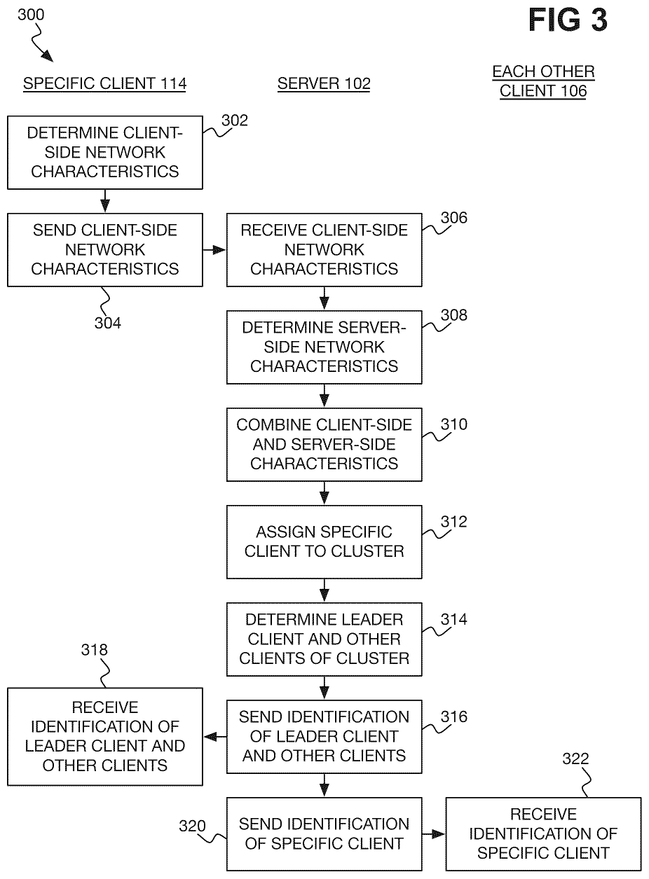

FIG. 3 shows an example method 300 for adding a specific client device 114 to a cluster 104 in order to receive push notifications from the server device 102. That is, before the method 200 of FIG. 2 can be performed, the specific client device 114 first has to be assigned to a cluster 104. The method 300 assumes that client devices 106 other than the specific client device 114 have already been clustered into clusters 104, and that each cluster 104 has a leader client device 108.

The specific client device 114 determines (e.g., collects) client-side network characteristics of itself (302). The client-side network characteristics of the client device 114 can include information such as the network address of the gateway device of the network to which the device 114 is connected, the network address of the device 114 itself, the identifier of the device 114 (e.g., a media-access controller (MAC) address), and/or other network information. Other such network information can include the identifier of a virtual local-area network (VLAN) to which the client device 114 belongs, for instance.

The network characteristics collected by the specific client device 114 itself are client-side network characteristics insofar as they are network characteristics from the perspective of the client device 114 itself. These network characteristics may not be visible from outside the client device 114 or outside the immediate network of which the device 114 is a part, or may be different than the network characteristics of the client device 114 that are visible from outside the device 114 or its immediate network.

For example, the network address of the specific client device 114 may be a private Internet protocol (IP) address assigned by the gateway device of the network to which the device 114 is connected, when network address translation (NAT) is used. This private IP address is not visible from outside the immediate network of the client device 114. From the perspective of outside the client device 114, the device 114 may have a different network address, specifically a public IP address of the gateway device itself.

The specific client device 114 sends its client-side network characteristics 304 to the server device 102 (304), which accordingly receives them (306). The server device 102 in turn determines server-side network characteristics of the client device 114 (308). The server-side network characteristics are the network characteristics of the client device 114 from the perspective of the server device 102 (i.e., from outside the device 114 and/or from outside the immediate network of the device 114). The server-side network characteristics may be determined via the session traversal utilities for NAT (STUN) protocol, for instance.

The server device 102 combines the client-and server-side network characteristics to generate overall network characteristics of the specific client device 114 (310). For example, the server-side network characteristics may be concatenated to the client-side network characteristics, or be combined with the client-side network characteristics in a different manner.

The server device 102 assigns the specific client device 114 to a cluster 104 using the overall network characteristics of the client device 114 (312). The specific client device 114 is therefore assigned to the cluster 104 based on network proximity, such that the client device 114 has network proximity to other client devices 106 of that cluster 104.

As one example, the network proximity between the specific client device 114 and each client device 106 of each cluster 104 may be determined. In the case of physical proximity, the network proximity may be determined as an estimated physical distance of the client device 114 to each client device 106. In the case of logical proximity, the network proximity may be determined as an estimated latency or other logical distance of the client device 114 to each client device 106.

The network proximity of the specific client device 114 to each cluster 104 may then be determined by averaging the network proximity of the client device 114 to each client device 106 of that cluster 104. The client device 114 may be assigned to the cluster 104 to which it has closest network proximity in this example.

The server device 102 determines the leader client device 108 and the other client devices 109 of the assigned cluster 104 (314), such as by looking up this information in a database. The server device 102 then sends the identification of the leader client device 108 and the other client devices 109 to the specific client device 114 (316), which accordingly receives this information (318). The identification of a client device 106 includes the network information of the device 106 needed to communicate with the device 106.

The server device 102 similarly sends the identification of the specific client device 114 to each other client device 106 of the cluster 104 in question (320), which thus receive this information (322). The identification of the device 114 may be broadcast or individually transmitted to the client devices 106. The identification may instead be transmitted just to the leader client device 108 of the cluster 104, which then sends this information to the other client devices 109.

When new client devices 106 are added to the clusters 104 per the method 300, individual clusters 104 may become too large in number. Therefore, the client devices 106 may be reclustered into new clusters 104. Reclustering may occur periodically for all clusters 104, or for an individual cluster 104 when it has too many client devices 106. In the latter case, the cluster 104 in question is replaced by multiple smaller clusters 104.

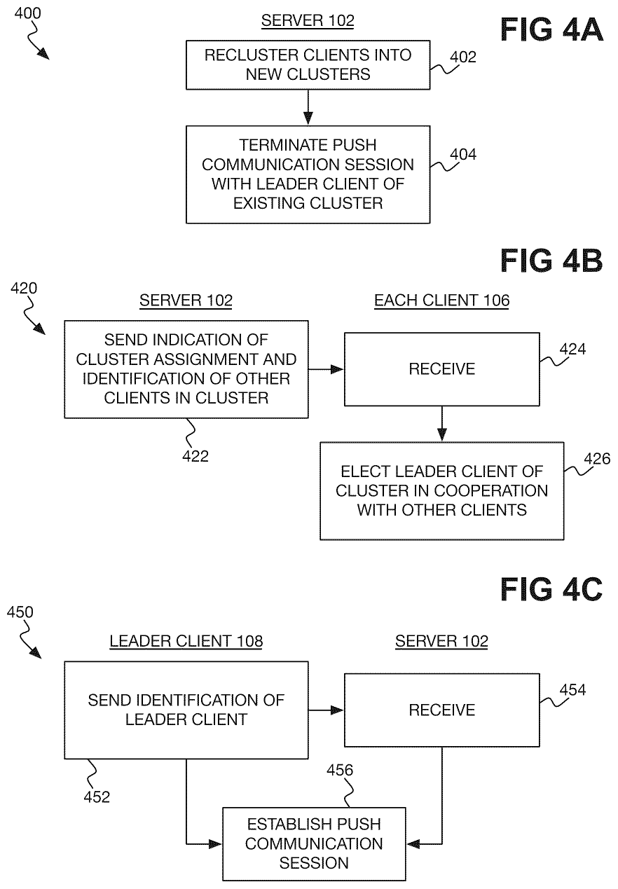

FIGS. 4A, 4B, and 4C respectively show methods 400, 420, and 450 that are performed when the client devices 106 are reclustered into new clusters 104. In the method 400 of FIG. 4A, the server device 102 thus reclusters the client devices 106 into new clusters 104 (402). Different clustering techniques can be used, where the client devices 106 are clustered based on network proximity. Example such techniques include centroid-based clustering, density-based clustering, distribution-based clustering, and hierarchical-based clustering, among others.

The server device 102 further terminates the established push communication session 110 with the leader client device 106 of each existing cluster 104 in question (404). For example, if the method 400 is performed to recluster the client devices 106 of one cluster 104, then the communication session 110 for that cluster 104 is terminated. If the method 400 is performed to recluster the client devices 106 of all the clusters 104, then all the sessions 110 are terminated.

The method 420 of FIG. 4B is then performed for each new cluster 104 of client devices 106. For a given cluster 104, the server device 102 sends to each client device 106 assigned to that cluster 104 an identification of the cluster 104 and the identification of each other client device 106 of the cluster 104 (422). The cluster 104 at this time does not have a leader client device 108 yet, and therefore the server device 102 broadcasts or individually sends this information to the client devices 106.

The identification of the cluster 104 may be a unique identifier to distinguish the cluster 104 from other (current, prior, and future) clusters 104. The identification of the cluster 104 may instead just be the identification of each client device 106 that has been assigned to the cluster 104. In either case, the server device 102 may also send an indication to each client device 106 that it has been assigned to a new cluster 104.

The client devices 106 accordingly receive this information (424). The client devices may elect a leader client device 108 from among themselves (426), as one way by which the leader client device 108 is determined. The client devices 106 of a cluster 104 can elect their leader client device 108 in accordance with any of a number of different leader election techniques. Such techniques include ring-based leader election techniques, mesh-based leader election techniques, and universal leader election techniques, among others.

The method 450 of FIG. 4C is performed once a leader client device 108 for a cluster 104 has been elected. The leader client device 108 specifically sends identification of itself to the server device 102 (452), which therefore receives this information (454). The leader client device 108 and the server device 102 then establish a push communication session 110 between themselves (456), such as a persistent connection per the WebSocket protocol, a long-term HTTP connection per long polling, and so on.

The methods 400, 420, and 450 presume that there are already clusters 104 of client devices 106 for which leader client devices 108 have been selected. At the outset, however, the very first client device 106 that requests to receive notifications from the server device 102 may be assigned to its own cluster 104 (i.e., a new cluster 104 including only this client device 106), and by default becomes the leader client device 108 of the cluster 104. Each subsequent client device 106 that requests to receive notifications may be added to the cluster 104, until at some point the client devices 106 are reclustered.

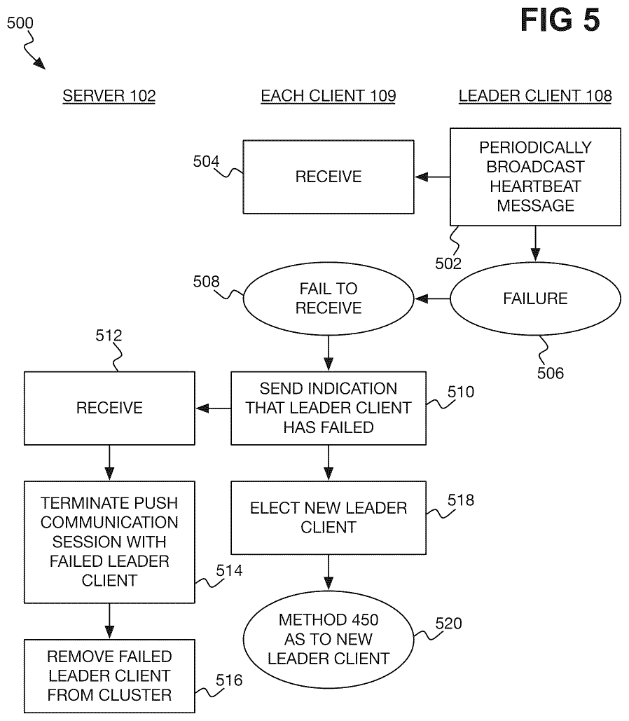

FIG. 5 shows an example method 500 that is performed when a leader client device 106 of a cluster 104 has failed, and which is for detecting that the leader client device 106 has failed in the first place. The leader client device 106 periodically broadcast heartbeat messages to the other client devices 109 of its cluster 104 (502). The other client devices 109 thus periodically receive these heartbeat messages (504).

If the leader client device 106 fails (506), however, this means that the other client devices 109 of the cluster 104 will fail to receive heartbeat messages from the leader client device 106 (508). Accordingly, the other client devices 109 can conclude that the leader client device 106 has failed when a threshold has been satisfied. For example, if more than a threshold number of consecutive heartbeat messages have not been received as expected, the other client devices 109 may conclude that the leader client device 106 has failed.

The other client devices 109 send an indication that the leader client device 106 has failed to the server device 102 (510), which receives this information (512). The server device 102 terminates the push communication session 110 that was established with the leader client device 106 (514), and removes the failed leader client device from the cluster 104 (516). The client devices 109 remaining in the cluster 104 elect from among themselves a new leader client device 108 (518), which notifies the server device 102 and establishes a new push communication session 110 per the method 450 (520).

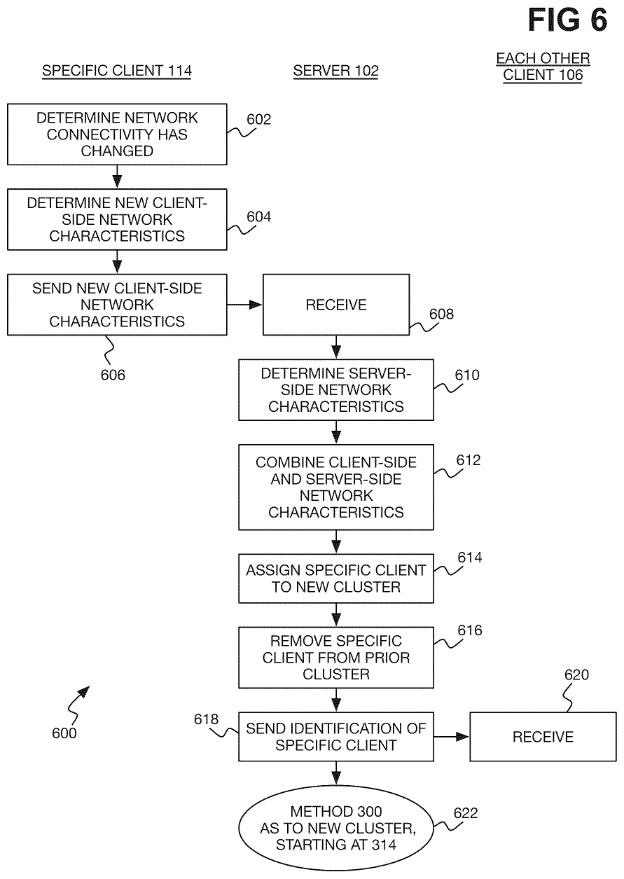

FIG. 6 shows an example method 600 that is performed when the network connectivity of a client device 106 has changed, and is described in relation to the specific client device 114. For example, the client device 114 may initially be connected to a wired network, but then be disconnected from the wired network and connected to a wireless network instead. As another example, the client device 114 may at first be connected to a wireless network such as a Wi-Fi network, but then be disconnected from the Wi-Fi network and instead connected to a cellular or mobile network, such as an LTE or 5G network.

The specific client device 114 determines that its network connectivity has changed (602). For example, the network address of the gateway device, the private IP address of the client device 114, or another subset of the client-side network characteristics of the device 114 may be periodically monitored. A change in this information can accordingly signify that network connectivity of the device 114 has changed.

In this case, the specific client device 114 determines its new client-side network characteristics (604), and sends this information to the server device 102 (606). The server device 102 receives these client-side network characteristics (608), and redetermines the server-side network characteristics of the client device 114 (610). The server device 102 combines the new client-and server-side network characteristics (612), and in the example assigns the client device 114 to a new cluster 104 based on the resulting overall network characteristics (614).

The server device 102 removes the specific client device 114 from its prior cluster 104 (616), and sends the identification of the specific client device 114 to the other client devices 106 of this cluster 104 (618). These client devices 106 accordingly receive this information (620). The method 300 is then performed as to the new cluster 104 starting at part 314 (622).

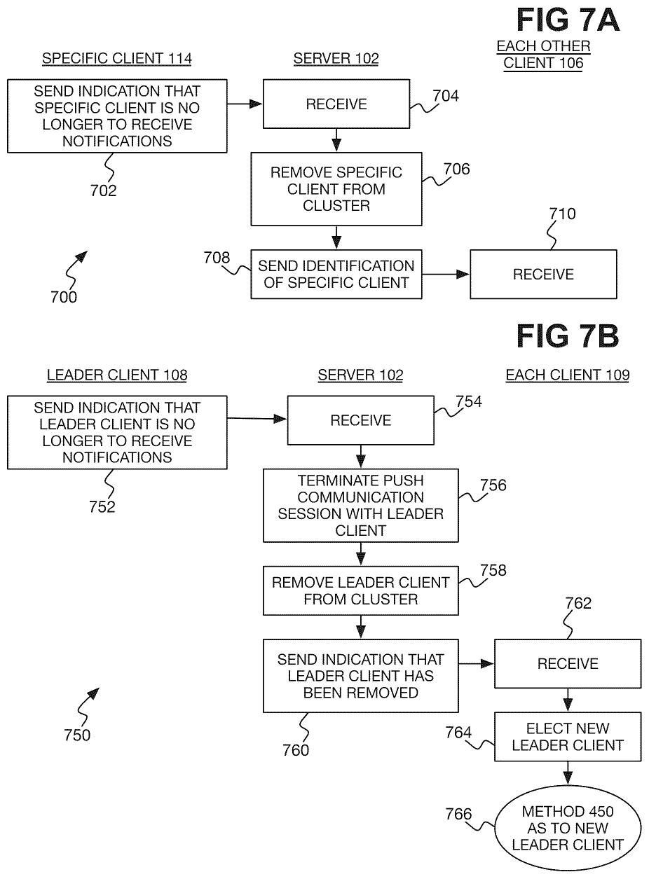

FIGS. 7A and 7B respectively show example methods 700 and 750 that are performed when a client device 106 of a cluster 104 is no longer to receive push notifications. The method 700 of FIG. 7A pertains to the case in which a client device 109 other than a leader client device 108 is no longer to receive notifications, and is described in relation to the specific client device 114.

The client device 114 may thus send an indication to the server device 102 that it no longer wishes to receive notifications (702). The server device 102 receives this indication (704), and removes the client device 114 from its cluster 104 (706). The server device 102 also sends the identification of the specific client device 708 to each other client device 106 in the cluster 104 (708), which receive this information (710).

The method 750 of FIG. 7B pertains to the case in which a leader client device 108 is no longer to receive notifications. The leader client device 108 may similarly send an indication that it no longer wishes to receive notifications to the server device 102 (752), which accordingly receives this information (754). The server device 102 terminates the push communication session 110 that was established with the leader client device 108 (756), and removes the device 108 from its cluster 104 (758).

The server device 102 sends an indication to the other client devices 109 in the cluster 104 that the leader client device 108 has been removed (760), which receive this information (762). The client devices 109 then elect a new leader client device 108 from among themselves (764). The method 450 is performed as to the new leader client device 108 (766), so that the server device 102 learns which client device 109 is the new leader client device 108 and establishes a new push communication session 110 with this device 108.

Techniques have been described for cluster-based notifications. A server device 102 sends a notification 112 intended for a specific client device 114 to the leader client device 106 of the cluster 104 to which the client device 114 has been assigned, rather than directly to the device 114 itself. The leader client device 106 in turn directly sends the notification 112 to the specific client device 114.

The described techniques can therefore improve push technology (i.e., server push). The described techniques can permit more client devices 106 to be served by a given server device 102, since the server device 102 does not have to maintain a push communication session 110 with each individual device 106. The described techniques can improve notification service scalability, insofar as when the client devices 106 of a cluster 104 are to be handled by a different server instance, just one push communication session 110 has to be terminated at the current server instance and reestablished at the new instance.

Furthermore, while the techniques have been described in relation to push notifications—i.e., where a push communication session 110 is established between a server device 102 and the leader client device 108 of a cluster 104—more generally the techniques can be applied to pull notifications as well. In this case, the communication session 110 may be in accordance with push or pull techniques, and thus may be a push communication session or a pull communication session.

For instance, the leader client device 108 of a cluster 104 may engage in short polling of the server device 102, or in medium polling that is between short and long polling. As an example, a communication session 110 may be held by the leader client device 108 with the server device 102 for just a minute as opposed to an hour, etc., as may be in the case in long polling. Since just the leader client device 108 of a cluster 104, and no other client devices 109 of the cluster 104, poll the server device 102, overall efficiency is still improved.

We claim:

1. A non-transitory computer-readable data storage medium storing program code executable by a processor of a server device to perform processing comprising:
determining a notification for a specific client device;
determining a cluster of client devices to which the specific client device has been assigned based on network proximity such that the client devices of the cluster have network proximity to one another;
determining a leader client device of the cluster; and
transmitting the notification for the specific client device to the leader client device over a communication session between the server device and the leader client device, such that the leader client device transmits the notification to the specific client device.

2. The non-transitory computer-readable data storage medium of claim 1, wherein no communication sessions currently exist between the server device and the client devices of the cluster other than the leader client device.

3. The non-transitory computer-readable data storage medium of claim 1, wherein the server device transmits the notification for the specific client device only to the leader client device and not to the specific client device.

4. The non-transitory computer-readable data storage medium of claim 1, wherein the processing further comprises:
receiving, from the specific client device, client-side network characteristics of the specific client device from a perspective of the specific client device and as determined by the specific client device itself;
determining server-side network characteristics of the specific client device from a perspective of the server device;
combining the client-side and server-side network characteristics to generate overall network characteristics of the specific client device; and
assigning the specific client device to the cluster, using the overall network characteristics.

5. The non-transitory computer-readable data storage medium of claim 1, wherein the processing further comprises:
reclustering the client devices in the cluster into a plurality of new clusters, such that each client device is assigned to one of the new clusters;
terminating the communication session between the server device and the leader client device;
for each new cluster, sending each client device assigned to the new cluster identification of other client devices assigned to the new cluster;
for each new cluster, receiving identification of a leader client device of the new cluster that has been elected by the client devices assigned to the new cluster; and
for each new cluster, establishing, a communication session between the server device and the leader client device of the new cluster.

6. The non-transitory computer-readable data storage medium of claim 5, wherein the notification is a first notification, and the processing further comprises:
determining a second notification for the specific client device; and
transmitting the second notification to the leader client device of the new cluster to which the specific client device has been assigned, the second notification transmitted over the communication session between the server device and the leader client device.

7. The non-transitory computer-readable data storage medium of claim 1, wherein the processing further comprises:
receiving, from at least one client device of the cluster, indication that the leader client device has failed;
terminating the communication session between the server device and the leader client device that has failed;
receiving identification of a new leader client device of the cluster that has been elected by the client devices; and
establishing a communication session between the server device and the new leader client device.

8. The non-transitory computer-readable data storage medium of claim 7, wherein the notification is a first notification, and the processing further comprises:
determining a second notification for the specific client device of the cluster; and
transmitting the second notification to the new leader client device over the communication session between the server device and the new leader client device.

9. The non-transitory computer-readable data storage medium of claim 1, wherein the communication session is a push communication session.

10. The non-transitory computer-readable data storage medium of claim 1, wherein the communication session is a pull communication session.

11. A client device comprising:
a processor; and
a memory storing program code executable by the processor to perform processing comprising:
determining client-side network characteristics of the client device from a perspective of the client device;
sending the client-side network characteristics to a server device;
receiving, from the server device, identification of other client devices of a cluster to which the server device has assigned the client device based on network proximity such that the client device and the other client devices have network proximity to one another;
receiving, from the server device, identification of a leader client device of the cluster; and
receiving, from the leader client device, a notification for the client device that the leader client device received from the server device over a communication session between the server device and the leader client device.

12. The client device of claim 11, wherein the processing further comprises:
receiving, from the server device, indication that the client device has been assigned to a new cluster, and identification of other client devices assigned to the new cluster; and
electing, in cooperation with other client devices assigned to the new cluster, a leader client device of the new cluster.

13. The client device of claim 12, wherein the notification is a first notification, the client device is not the leader client device of the new cluster, and the processing further comprises:
receiving, from the leader client device of the new cluster, a notification for the client device that the leader client device received from the server device over a communication session between the server device and the leader client device.

14. The client device of claim 11, wherein the processing further comprises:
periodically receiving heartbeat messages broadcast by the leader client device of the cluster;
upon failing to periodically receive the heartbeat messages in satisfaction of a threshold, sending indication to the server device that the leader client device of the cluster has failed; and
electing, in cooperation with the other client devices assigned to the cluster, a new leader client device of the cluster.

15. The client device of claim 11, wherein the notification is a first notification, and the processing further comprises:
determining that network connectivity of the client device has changed;
determining new client-side network characteristics of the client device from the perspective of the client device;
sending the new client-side network characteristics to the server device;
receiving, from the server device, identification of other client devices of a new cluster to which the server device has assigned the client device based on network proximity;
receiving, from the server device, identification of a leader client device of the new cluster; and
receiving, from the leader client device of the new cluster, a second notification for the client device that the leader client device received from the server device over a communication session between the server device and the leader client device.

16. The client device of claim 11, wherein the processing further comprises either or both of:
receiving, from the server device, identification of a new client device that has been added to the cluster by the server device; and
receiving, from the server device, identification of one of the other client devices that has been removed from the cluster by the server device.

17. The client device of claim 11, wherein the communication session is a push communication session or a pull communication session.

18. A method comprising:
sending, by a leader client device of a cluster of client devices, identification of the leader client device to a server device that assigned the client devices to the cluster based on network proximity such that the client devices have network proximity to one another;
establishing, by the leader client device, a communication session between the leader client device and the server device;
receiving, by the leader client device, a notification for a specific client device of the cluster from the server device; and
transmitting, by the leader client device, the notification to the specific client device.

19. The method of claim 18, wherein no communication sessions currently exist between the server device and client devices of the cluster other than the leader client device,
and wherein the server device transmits the notification for the specific client device only to the leader client device and not to the specific client device.

20. The method of claim 18, herein the communication session is a push communication session or a pull communication session.
